(19) United States
(12) Patent Application Publication
(10) Pub. No.: US 2006/0214916 A1
(43) Pub. Date: Sep. 28, 2006

(54) Miniaturised keyboard

(76) Inventor: Andrew Mulford, Edinburgh (GB)

Correspondence Address: FLESHNER & KIM, LLP, P.O. BOX 221200, CHANTILLY, VA, 20153, US

(21) Appl. No.: 10/549,616

(22) PCT Filed: Mar. 17, 2004
(86) PCT No.: PCT/GB04/01138

§ 371 Date: Feb. 24, 2006

(30) Foreign Application Priority Data
Mar. 20, 2003 (GB) 0306475.5

(51) Int. Cl. G09G 5/00

(52) U.S. Cl. 345/169

(57) ABSTRACT

A keyboard (1) that comprises for miniaturisation of the keyboard (1) while maintaining efficient use of the keyboard (1) by an operator is described. The keyboard (1) comprises a first keyboard section (2) that contains the character input keys (4) and a second independent keyboard section 3 that contains the usual command keys (5). The two keyboard sections are pivotally attached so that the keyboard (1) can be moved between and open desktop configuration and a closed, hand-held configuration. As a result the keyboard (1) is capable of being employed as a desktop keyboard, a hand-held keyboard. When configured as a hand-held keyboard the keyboard (1) may also be employed as a games controller, a mobile phone or as a remote control device.

The present invention relates to a keyboard. In particular, the invention relates to a keyboard that comprises a key layout that allows for miniaturisation while maintaining efficient use by a keyboard operator.

Over recent years there has been steady progress made in the art of miniaturising keyboards due to the continued miniaturisation of electronic components. These miniaturised keyboards find application in the fields of portable computers, mobile phones and electronic games controllers. Most of the keyboards for portable computers are still based on the standard “QWERTY” key layout wherein the letter keys are enclosed by number and symbol keys across the top edge and command keys around the remaining edges. Typically, these keyboards are designed to be used on a desktop and so limit the true portability of these devices. Those keyboards that are designed to be hand held are typically limited to use with only the thumbs of an operator.

The main restriction on the continued miniaturisation of these keyboards is the fact that keyboard operator's fingers can not themselves be miniaturised. Therefore, although electronic components continue to get smaller the advantage of this increased miniaturised can not be fully exploited by the present keyboard designs. Present keyboard designs are also the main limiting factor in the continued miniaturisation of mobile phones.

Furthermore, the design of keyboards employed for portable computers, mobile phones and electronic games controllers have each evolved separately resulting in their own data input and control devices that require different operating skills by the user. Current attempts to integrate one or more of these keyboard designs have resulted in keyboards that are clumsy and so inefficient for operators to use.

It is an object of an aspect of the present invention to provide a keyboard design that provides good miniaturisation capabilities while allowing for efficient use by a keyboard operator.

A further object of an aspect of the present invention is to provide a keyboard design that provides good miniaturisation capabilities and so allows for the integration of the functionality of a standard computer keyboard, a mobile phone and an electronic games controller.

According to a first aspect of the present invention there is provided a keyboard for use by an operator comprising a first keyboard section containing a plurality of character input keys, a first edge that is located adjacent to the operator during normal use of the keyboard and a second keyboard section containing a plurality of command input keys wherein the second keyboard section is located between the first keyboard section and the first edge and is displaced from the first keyboard section.

Preferably the plurality of character input keys comprise keys for inputting printable characters selected from the group comprising alpha numeric, symbols and punctuation characters.

Preferably the plurality of command input keys comprise keys for inputting commands selected from the group comprising tab, capitals lock, numbers lock, shift, control, alt, back space, insert, delete, home, end, page up, page down, mouse control, escape, and function keys.

Preferably the keyboard further comprises connection means for connecting the keyboard to a remote computer system. Optionally the connection means comprises a signal transmitter.

Most preferably the first keyboard section and the second keyboard section are pivotally attached so that the second keyboard section can be moved from the displaced position to a second position located below the first keyboard section.

Optionally, when the second keyboard section is moved to the second position the function of the command input keys are remapped so as to maintain the relative position of the function of the command input keys to that provided in the displaced position.

Preferably the first keyboard section further comprises a multidirectional key and a mouse stick and the command input keys are mapped to provide a plurality of trigger buttons so enabling the keyboard to be employed as a games controller.

Preferably the first and second keyboard sections comprise side cut recesses.

Preferably the first keyboard section comprises a representation of the configuration of the function of the command input keys when the second keyboard section is located in the second position.

Optionally when the second keyboard section is moved to the second position the first keyboard section is deactivated.

Optionally when the second keyboard section is moved to the second position the keyboard functions as a remote control device. Alternatively the second keyboard section comprises a mobile phone screen such that when the second keyboard section is moved to the second position the keyboard functions as a mobile phone.

Optionally the keyboard further comprises a main screen.

Preferably the main screen is pivotally attached to the first keyboard section so that it moves between a first position where the main screen can be viewed and a second position where the main screen can not be viewed.

Most preferably when the main screen is the second position it provides a physical barrier to the character input keys.

Preferably the keyboard is made of a plastic material.

Preferably the character input keys and the command keys comprise keys that are ergonomically optimised.

Aspects and advantages of the present invention will become apparent upon reading the following detailed description and upon reference to the following drawings in which:

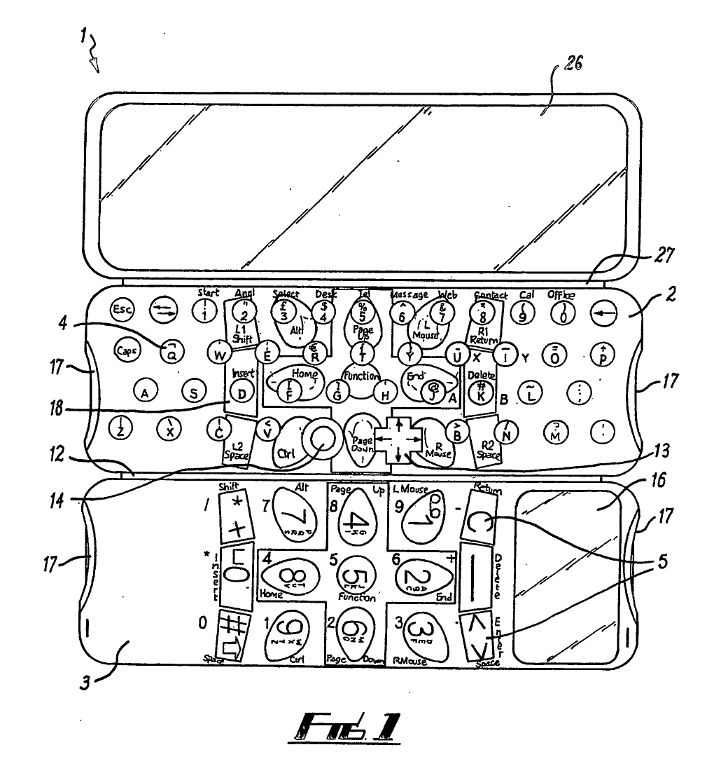

FIG. 1 presents a schematic representation of a keyboard in accordance with an aspect of the present invention;

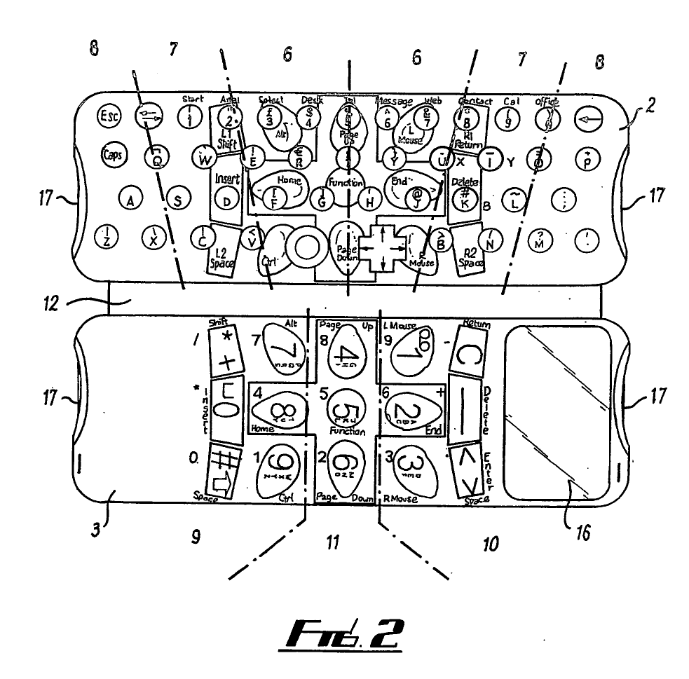

FIG. 2 presents a schematic representation of an operator's finger positions employed with the keyboard of FIG. 1;

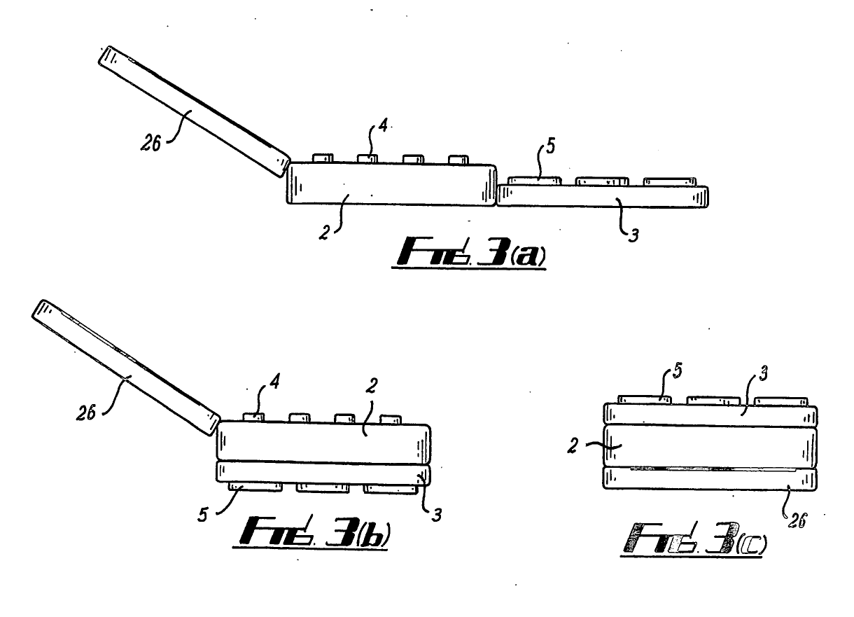

FIG. 3 presents a side elevation of the keyboard of FIG. 1 when arranged in a:
a) Open, desktop configuration;
b) Closed, hand-held configuration; and
c) Closed, hand-held configuration with a main screen also in a closed position;

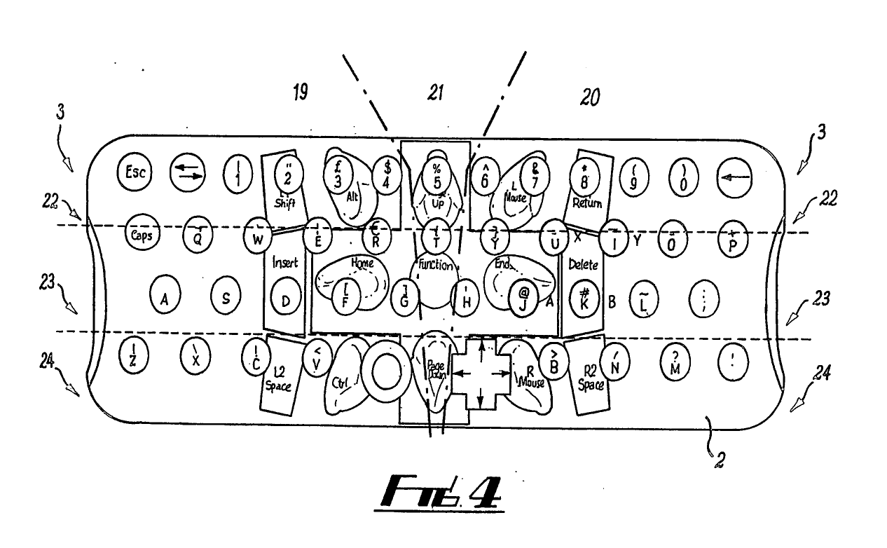

FIG. 4 presents a schematic representation of an operator's finger positions when the keyboard is employed in the closed, hand-held configuration of FIG. 3(b);

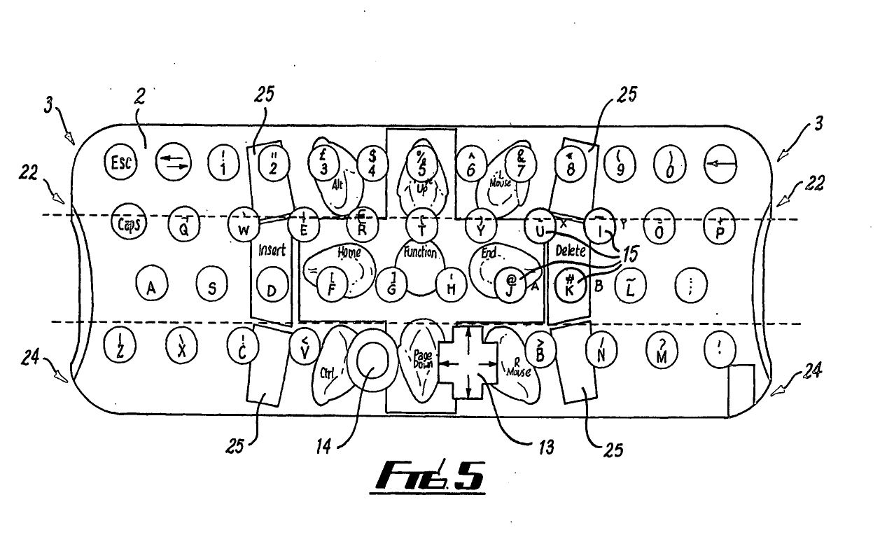

FIG. 5 presents a schematic representation of an operator's finger positions when the keyboard is employed in the closed, configuration of FIG. 3(b) as a games controller.

Referring to FIG. 1 a schematic representation of a keyboard 1 in accordance with an aspect of the present invention is presented. The keyboard 1 can be seen to comprise a first keyboard section 2 and a second keyboard section 3 displaced from the first towards the normal operating position of a keyboard user. A connection means (not shown) allows the keyboard to be incorporated directly with any computer system, as and when required. The connection means can be in the form of hard wiring or alternatively via remote access by incorporating a signal transmitter (not shown) within the keyboard 1.

The first keyboard section 2 comprises character input keys 4, namely letter, number and symbol keys arranged in a standard “QWERTY” style layout. The second keyboard section 3 comprises the majority of the usual command input keys 5 found on a standard keyboard i.e. shift, control, alt, delete, insert, home, end, page up, page down, mouse control, and function keys.

FIG. 2 presents a schematic representation of an operator's finger positions when the keyboard 1 is employed. As can be seen the first keyboard section 2 is divided into regions for the operator's forefingers 6, middle fingers 7, ring and small fingers 8 while the second keyboard section 3 is divided into regions for use by the thumbs of an operator. In particular, the left thumb controls the keys within a left thumb region 9, the right thumb controls the keys within a right thumb region 10 and either thumb controls the keys within the central thumb region 11.

The development of the second keyboard section 3 allows for the keyboard 1 to be miniaturised while maintaining efficiency of use by an operator when compared to those keyboard designs already known to those skilled in the art. In particular, the efficiency of use of the keyboard is maintained by the location of all of the command keys 5 within an area that can be easily accessed by the thumbs of the operator while the character input keys 4 still allow for eight finger touch typing.

It will be obvious to those skilled in the art that alternative key arrangements to the “QWERTY” style arrangement can also be employed within the first keyboard section 2. For example in an alternative embodiment (not shown) a “DVORAK” key arrangement is employed within the first keyboard section 2.

The design of the keyboard 1 can be further exploited so as to further increase the miniaturisation of the device and to allow increased functionality to be achieved by an operator. Referring to FIG. 1 the keyboard 1 can be seen to further comprise a first hinge 12 located between the first 2 and second keyboard sections 3.

The first keyboard section can also be seen to further comprise a multidirectional key 13, a mouse stick 14 and four games control keys 15. The games control keys 15 are simply letter keys 4 produced in different colours so as to allow then to be easily identified from the other letter keys 4 located on the first keyboard section 2.

Furthermore, the second keyboard sections 3 can be seen to further comprise a mobile phone screen 16. The command keys 5 of the second keyboard sections 3 can be mapped so as to function as a standard mobile phone keyboard, as a remote control device, or as the trigger buttons for a games controller, as explained in detail below.

From an analysis of FIG. 3 the integrated nature of the keyboard 1 becomes readily apparent. FIG. 3(a) presents a side elevation of the keyboard 1 of FIG. 1 in a fully expanded, desktop configuration.

Moving to FIG. 3(b) the second keyboard section 3 has been pivoted about the first hinge 12 so that the second keyboard section 3 now locates below the first keyboard section 2. In this orientation the keys 4, 13, 14 and 5 of both the first 2 and second keyboard sections 3 remain accessible to the operator. This configuration is referred to as the closed, hand-held configuration. In the closed, hand-held configuration the keyboard 1 is specifically designed to be held and operated by both hands, as detailed below, thus providing true portability during use, for example when employed on trains or planes. Indeed to aid in this process side cut recesses 17 are located in the first 2 and second keyboard sections 3 to aid gripping by the knuckles of the forefingers.

It should also be noted that when the second keyboard section 3 is located below the first keyboard section 2 the functional layout of the command keys 5 is remapped. This is carried out in order to maintain the position of the command keys 5, and the relationship between them, with that provided when the keyboard 1 is in the desktop configuration. For example the “9” key on the second keyboard section 3 is ascribed the “Ctrl” function in the expanded, desktop configuration. However, in the closed, hand-held configuration the “Ctrl” function moves to the “7” key which now occupies that position. To aid location by an operator of the keyboard 2 in this configuration the layout of the command keys 5 on the second keyboard section 3 is reproduced in shadow form 18 on the first keyboard section 2.

FIG. 4 presents a schematic representation of an operator's finger positions when the keyboard 1 is employed in the closed, hand-held configuration of FIG. 3(b). As can be seen the operator's thumbs are employed to control the character input keys 4 on the first keyboard section 2. In particular the left thumb operates the keys within a left thumb region of the first keyboard section 19 while the right thumb operates the keys located within a right thumb region 20. Either thumb is then available to operate the keys within a middle region of the first keyboard section 21. The operator's forefingers, middle fingers, ring and/or small fingers then control the command keys 5 located within a front region 22, a middle region 23 and a back region of the second keyboard section 24, respectively.

The keyboard 1 is capable of operating in different functional modes when in the closed, hand-held configuration. A “function” command key 5 is employed to toggle through the alternative functional modes.

A first functional mode corresponds to the keyboard 1 being employed as a games controller. Referring to FIG. 5 a schematic representation of an operator's finger positions when the keyboard 1 is employed in the closed configuration of FIG. 3(b) as a games controller is presented. In this mode the mouse stick 14 acts as a joystick, which together with the multidirectional key 13 and the game control keys 15 are operated by the thumbs of an operator. For this function the command keys 5 are mapped so as to provide trigger buttons 25 for the games controller. The trigger buttons 25 (Left 1 (L1), Left 2 (L2), Right 1 (R1) and Right 2 (R2)) are activated by an operator by the use of their forefingers and the ring fingers accessing the second keyboard section 3, as appropriate. As a result when employed as a games controller the keyboard 1 allows for multi-finger play by an operator.

The second and third functional modes can be considered as single hand modes of operation and correspond to the keyboard 1 functioning as a mobile phone and a remote control device, respectively. When in these modes of operation the first keyboard section 2 is redundant and so rendered inactive. In the mobile phone mode the second keyboard section 3 is mapped so that the keyboard 1 replicates the function of a mobile phone keyboard. Similarly, in the remote control device mode the second keyboard section 3 is mapped so that the keyboard 1 operates as a remote control keyboard for the remote control of a domestic appliance e.g. television, stereos, video player, DVD player etc.

FIGS. 1 and 3 presents a further alternative embodiment of the keyboard 1 where it comprises a main screen 26. The main screen 26 is attached to the first keyboard section 2 by a second hinge 27. In this embodiment the main screen 26 pivots about the second hinge 27 so that it moves between a first position, where the main screen 26 can be easily viewed (see FIGS. 1, 3(a) and 3(b)) and a second position where the screen 26 can not be viewed, FIG. 3(c). In particular when located in the second position the rear area of the screen 26 section provides a physical barrier for an operator to the keys 4, 13 and 14 of the first keyboard section 2. Furthermore, when moved to the closed position the main screen can be used to deactivate the first keyboard section. At this stage only the single hand modes of operation, namely the mobile phone mode and the remote control device mode are available for selection.

The keyboard 1 is made of a plastic material so as to allow for ease of manufacture and the ability to utilise colours to facilitate identification of the keys 4, 13, 14 and 5 and their function. The keys 4, 13, 14 and 5 are also shaped to optimise ergonomics in terms of the fingers used to operate them. For example “petal” shaped command keys 5 are employed on the second keyboard section 3. Furthermore, the casing of the keyboard 1 can further comprise protrusions (not shown) located around the keys 4, 13, 14 and 5 so as to aid the location of an operator's finger to the keys 4, 13, 14 and 5.

Aspects of the present invention have a number of advantages over those keyboards described in the prior art. In the first instance the two keyboard section design provides a means for miniaturising keyboards whilst still allowing for an acceptable degree of efficiency of use by an operator i.e. still allowing for eight finger touch typing. This is achieved because the keyboard design moves the constraint on miniaturisation from being one of human anatomy to be one of hardware development.

Additional miniaturisation is also achieved through the introduction of hinges that allow the component sections to pivot relative to each other. These features provide the additional advantage that they allow for the keyboard to be configured for use as a desktop keyboard or as a hand held keyboard. The hand-held configuration is designed specifically to be held, and operated, by both hands so allowing for true portability of the keyboard. In the hand-held configuration the keyboard can be selected to operate as a games controller, as a mobile phone or as a remote control device.

It should be noted that all of the available keyboard modes can be obtained within a platform that is sized with a standard mobile phone. By allowing the majority of the keys to provide multiple functions there is a significant reduction in the overall number of keys required by the keyboard.

The foregoing description of the invention has been presented for purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention as defined by the appended claims.

1.-18. (canceled)

19. A keyboard for use by an operator, comprising:
a first keyboard section containing a plurality of character input keys;
a second keyboard section containing a plurality of command input keys; and
a first hinge that connects the keyboard sections so as to enable the keyboard to move between a desktop configuration, when the first hinge is in an open position, and a hand-held configuration, when the first hinge is in a closed position, such that the character input keys and the command input keys are accessible for use by an operator in both configurations.

20. A keyboard as claimed in claim 19, wherein the plurality of character input keys comprise keys for inputting printable characters selected from the group consisting of alpha numeric, symbols and punctuation characters.

21. A keyboard as claimed in claim 19, wherein the plurality of command input keys comprise keys for inputting commands selected from the group consisting of tab, capitals lock, numbers lock, shift, control, alt, back space, insert, delete, home, end, page up, page down, mouse control, escape, and function keys.

22. A keyboard as claimed in claim 19, wherein the keyboard further comprises a connection means for connecting the keyboard to a remote computer system.

23. A keyboard as claimed in claim 22, wherein the connection means comprises a signal transmitter.

24. A keyboard as claimed in claim 19, wherein when the keyboard is moved from the desktop configuration to the hand-held configuration functions associated with the command input keys are remapped so as to maintain the relative position of the functions of the command input keys in the hand-held configuration to that provided in the desktop configuration.

25. A keyboard as claimed in claim 24, wherein the first keyboard section further comprises a multidirectional key and a mouse stick and the command input keys are mapped to provide a plurality of trigger buttons so enabling the keyboard to be employed as a games controller.

26. A keyboard as claimed in claim 19, wherein the first and second keyboard sections comprise side cut recesses.

27. A keyboard as claimed in claim 24, wherein the first keyboard section comprises a representation of the function of the command input keys when the keyboard is in the hand-held configuration.

28. A keyboard as claimed in claim 19, wherein when the keyboard is moved to the hand-held configuration the first keyboard section is deactivated.

29. A keyboard as claimed in claim 19, wherein the second keyboard section functions as a remote control device when the keyboard is moved to the hand-held configuration.

30. A keyboard as claimed in claim 19, wherein the second keyboard section comprises a mobile phone screen such that the second keyboard section functions as a mobile phone when the keyboard is moved to the hand-held configuration.

31. A keyboard as claimed in claim 19, wherein the keyboard further comprises a main screen.

32. A keyboard as claimed in claim 31, wherein the main screen is pivotally attached to the first keyboard section by a second hinge so as to enable the main screen to move between a first position where the main screen can be viewed and a second position where the main screen cannot be viewed.

33. A keyboard as claimed in claim 32, wherein when the main screen is the second position it provides a physical barrier to the character input keys.

34. A keyboard as claimed in claim 19, wherein the keyboard is made of a plastic material.

35. A keyboard as claimed in claim 19, wherein the character input keys and the command keys comprise keys that are ergonomically shaped.
